(19) United States
(12) Patent Application Publication
(10) Pub. No.: US 2015/0151925 A1
(43) Pub. Date: Jun. 4, 2015

(54) FLUID SUPPORTED BELT RETURN

(71) Applicant: Thomas C. Hudson, Bessemer, AL (US)

(72) Inventor: Thomas C. Hudson, Bessemer, AL (US)

(73) Assignee: Hudco Industrial Products, Inc., Bessemer, AL (US)

(21) Appl. No.: 14/553,952

(22) Filed: Nov. 25, 2014

Related U.S. Application Data
(60) Provisional application No. 61/910,212, filed on Nov. 29, 2013.

(51) Int. Cl. B65G 45/22; B65G 15/60

(52) U.S. Cl. CPC B65G 45/22; B65G 15/60

(57) ABSTRACT

An air supported conveyor belt return reduces debris accumulation beneath the belt by shaping the belt to be higher in the center and supports it on a concave plenum wall that delivers air to the center so that debris migrates from under the belt due to the force of the air and gravity.

### FIELD OF INVENTION

The present invention relates to an apparatus for supporting a conveyor belt. More specifically, the apparatus of the present invention relates to a fluid plenum trough conveyor support that provides a near frictionless fluid film bearing to support a conveyor belt during both the supply bearing portion of the trough and on the return.

### BACKGROUND

Conveyor belt systems have been known and used in many industries for many years. Many of these systems utilize a continuous loop belt to transport bulk materials from one point to another. Traditionally the belt is supported by idler rollers, or troughing rollers which define a conveyor path. The drive means that translate the belt along the conveyor path must be capable of moving the weight of the materials as well as overcoming the frictional forces developed between the belt and the above described support means.

The conveyor systems described above have many drawbacks. First, each of the support rollers is subject to wear and mechanical failure. These failures can damage a belt or cause premature wear of the belt. Second, the rollers require routine maintenance. Often the location of these rollers within the conveyor system will pose significant hazards to maintenance personnel assigned to service these components. Other times, the location of these components will merely be an inconvenience. In either case these difficulties can lead to significant delays or equipment downtime while maintenance personnel service the equipment. Finally, each roller introduces a component of friction into the system, which must be overcome by the belt drive mechanism. These frictional components tend to increase as the rollers and their associated bearings wear, requiring additional energy consumption by the drive mechanism. In turn, the belt drive mechanism is subjected to additional wear, potentially causing premature mechanical failure.

Fluid plenum conveyor belt support elements have been introduced to overcome these limitations. They function by the introduction of a pressurized fluid source between the belt and a trough formed in the plenum to contain and guide the belt. The pressurized fluid forms a fluid film layer between the trough and the conveyor belt. The fluid film supports the weight of the belt and the materials transported thereon, while providing a near frictionless bearing surface between the belt and the trough. This concept provides distinct improvements over earlier roller methods. First, maintenance of the bearings is virtually eliminated by the elimination of the moving components of the earlier roller systems. Second, the fluid film bearing significantly reduces the amount of friction between the belt and supporting conveyor path. Finally, the reduction of frictional forces encountered by the belt permits operation of the conveyor drive mechanism at reduced power levels resulting in reduced energy costs and reduced wear and tear on the belt drive mechanism.

My previously granted U.S. Pat. No. 6,491,156 solved many of the foregoing problems and its teachings are incorporated herein by reference. Although the conveyor described and claimed in my prior patent was a significant improvement, we noted that the return of the conveyor belt was a source of high maintenance and concern in certain situations. Most HudcoAir® installations use conventional roller returns, however, occasionally the customer prefers the total enclosure provided by air supporting the belt return. Heretofore all air supported return plenums were designed with a concave trough, of approximately 10 to 20 degrees similar to the supply belt run as shown in the U.S. Pat. No. 6,491,156, based on the logic of using gravity to encourage the belt to track the conveyance centerline for its journey back to the tail pulley. The chronic problem with this arrangement is the build-up of residual material from “dirty side” of the belt which accumulates between the belt and the trough return. Therefore a method to overcome the static debris accumulation trough was needed.

### SUMMARY OF THE INVENTION

A general object of the invention is to improve the overall efficiency of air supported conveyors. More specifically, an object of the invention is to reduce the accumulation of residue in the area of the air supply orifices beneath the return conveyor to improve airflow beneath the conveyor belt. Another object of the invention is to reduce maintenance on air flow conveyors by making them more self cleaning and utilizing the edge of the belt to assist in removing debris from the belt support.

In one embodiment, my invention provides a gravity assist to the supporting air flow by forming the top of the air supply plenum as a convex or crowned surface with the air delivery orifices at or near the centerline of the surface such that air forced beneath the surface of the belt will flow outwardly and downwardly from the orifices beneath the belt thereby urging any debris from beneath the belt.

### BRIEF DESCRIPTION OF THE DRAWINGS

Referring to the drawings which are appended hereto and which form a portion of this disclosure, it may be seen that:

FIG. 1 is side elevational view of an air conveyor system;

FIG. 2 is plan view of an air conveyor system;

FIG. 3 is a perspective view of the improved air return profile;

FIG. 4 is an end view of the prior art system;

FIG. 5 is an end view of the present air return profile; and,

FIG. 6 is end view showing the shaping rollers.

### DETAILED DESCRIPTION

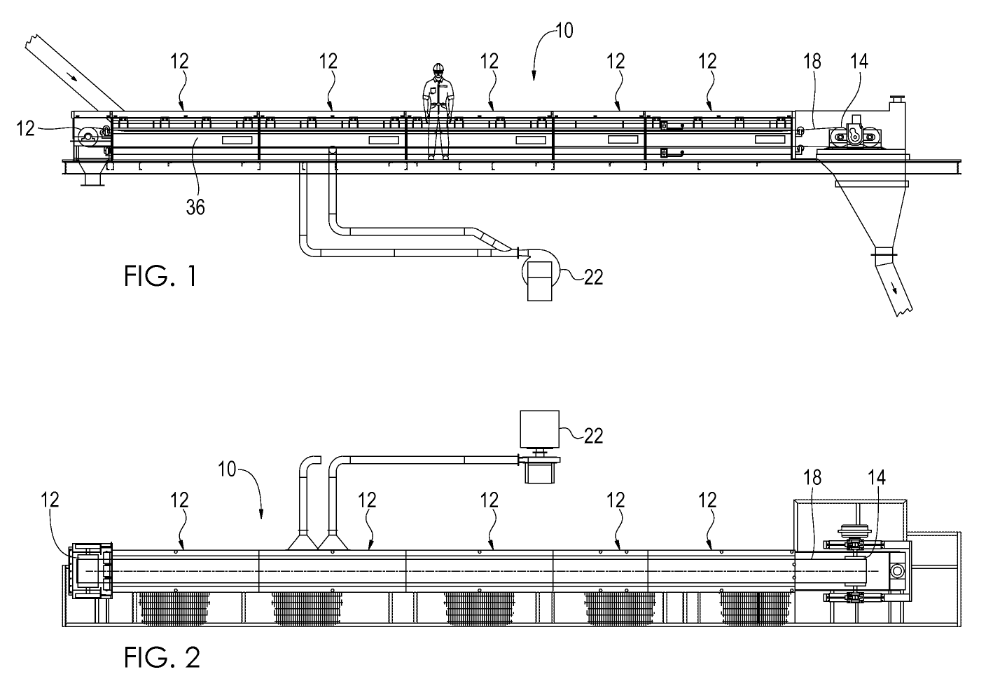

Referring to the drawings for a clearer understanding of the invention, it may be seen that FIGS. 1 & 2 show a conveyor system 10 comprised of a series of fluid plenum trough elements 12, the conveyor system 10 having a driven roller 14 and a return roller 16, with an endless belt 18 entrained about driven roller 14 and return roller 16. Support members , not shown, hold the fluid plenum conveyor path at a desired delivery angle and support the conveyor system. A pressurized fluid source 22 in fluid communication with plenum elements 12 provides the fluid for generating a substantially frictionless fluid film bearing surface between belt 18 and trough elements 12.

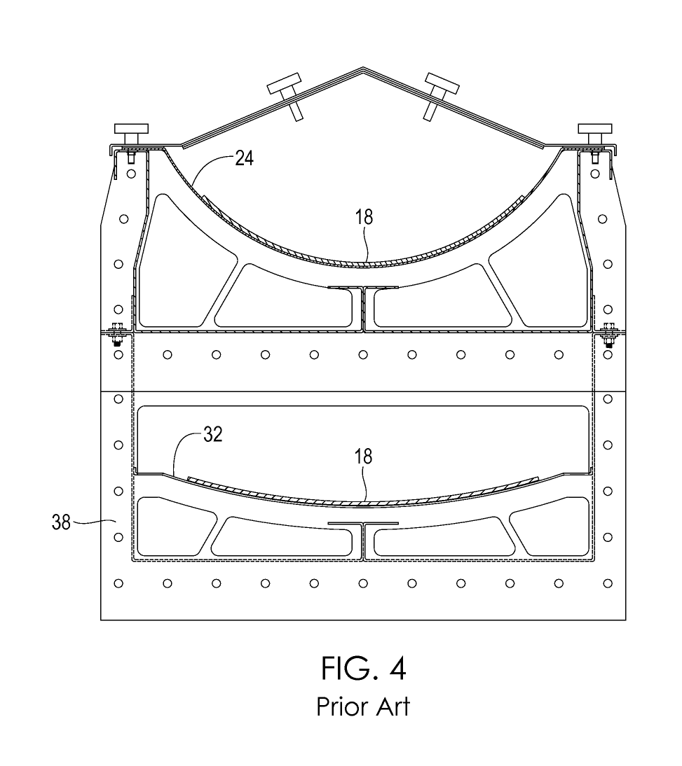

As is best seen in FIG. 4, the prior art fluid plenum return trough element 12 comprises a longitudinally extending trough panel 24 supporting a portion of endless belt 18, a housing 26, a pair of arcuate end plates 28, and a plurality of orifices 30 arrayed along the longitudinal length of trough panels 24. Per the teachings of the afore said U.S. Pat. No. 6,491,156, trough panels 24 have an arcuate, constant radius, transverse dimension extending symmetrically upward from each side of a vertical centerline. A fluid film is formed by communication of pressurized fluid F through orifices 30. The prior art return trough, as shown in FIG. 4 also, had a similar structure.

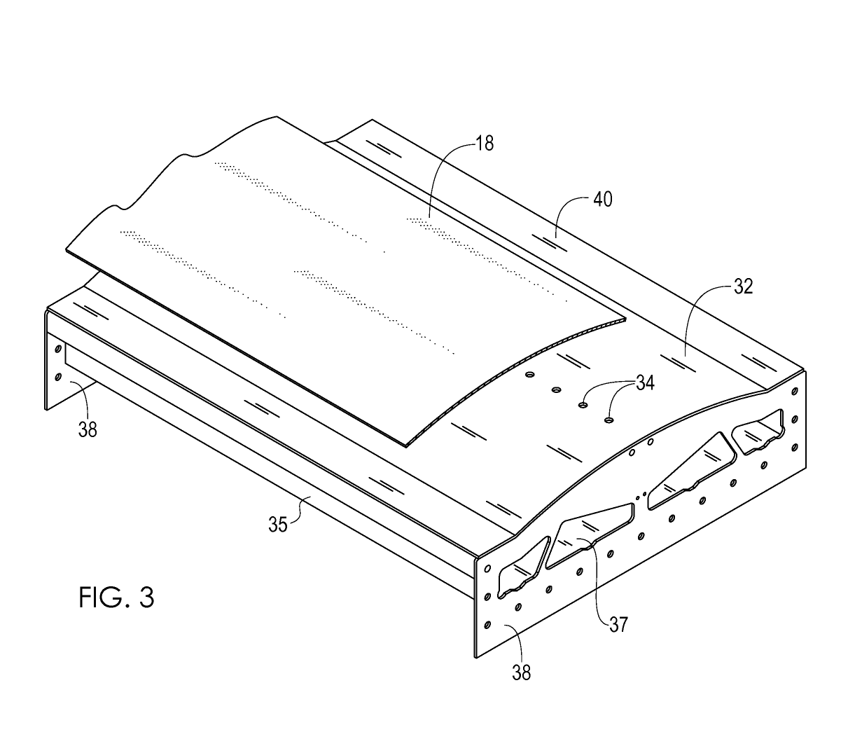

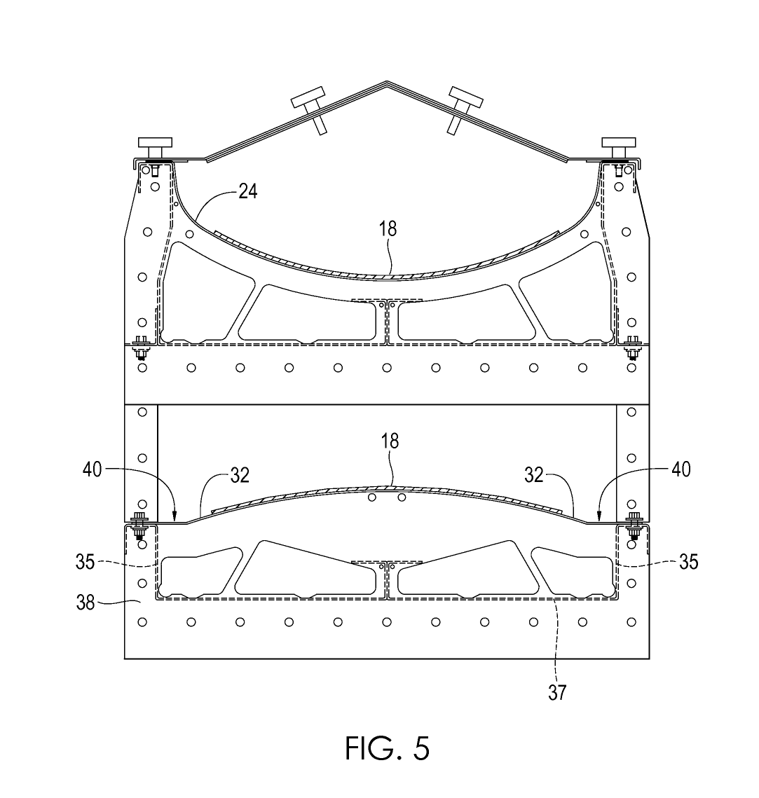

To alleviate the problem of debris accumulation in the bottom of the prior art return trough, we have tested a return plenum using an inverted or convex trough, as shown in FIGS. 3, 5 and 6. It should be understood that the return plenum is mounted below the longitudinally extending transport trough elements 24 and support the endless belt 18 during its return. An arcuate return panel 32 is formed by the upper wall of said plenum and supports a portion of endless belt 18 within a housing 36. A pan 33 having a pair of sidewalls 35 and bottom 37, shown in FIG. 3 and in phantom in FIG. 5, define the remainder of the chamber walls enclosing the plenum. A pair of arcuate end plates 38 support the return panel 32 and pan 33 of each section. A plurality of orifices 34 are arrayed along the longitudinal length of return panels 32 either as a single row of orifices or in a pattern of longitudinally and laterally spaced orifices near the centerline the panel 32. Belt 18 overlies the orifices and rides on a cushion of pressurized air supplied from fluid source 22 flowing through the orifices. The air orifices 34 are positioned along the centerline to alleviate the friction of the belt movement. Airflow from the orifices 34 beneath the belt encourages any debris to flow outward from the centerline and be deposited in the space along each longitudinal edge of the belt 18. Thus, debris beneath the belt will be urged longitudinally by the movement of the belt and laterally by the air flow and gravity. If the edge space 40 at the intersection of the return panel 32 and the housing 36 becomes filled, the movement of the belt edge pulls the debris toward the end of the conveyor to a desired dropout point where it harmlessly falls away by gravity or is removed by an exhaust system. It is to be understood that the operation is also optimized by a standard belt scraper and a Stafford dynamic belt cleaner which can loosen debris from the belt, while the present invention prevents the accumulation of debris beneath the belt. We have reduced to practice a conveyor using the inverted trough concept and found that it works better than we expected. The constant fluid airflow lubricates the movement and displaces the dirt to the edge of the belt.

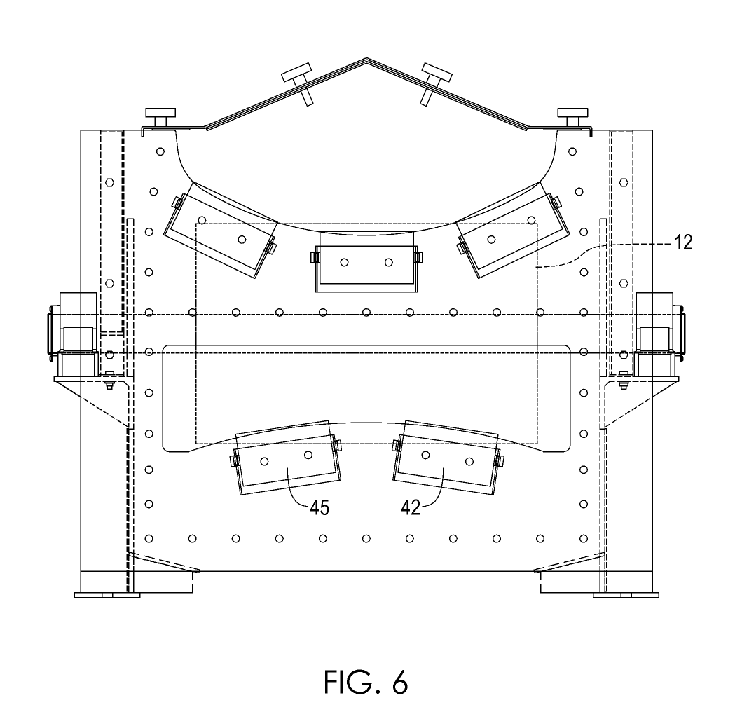

It should be noted that the contour of the belt 18 is transformed after it passes over return roller 16 by a pair of shaping rollers 42 shown in FIG. 6 that are offset about 20 degrees from horizontal such that the belt is convex when it begins its transit along the return panels. It should also be noted that the belt is partially cleaned before reaching the return panels by an air knife 44 near the shaping rollers 42. Return panels 32 have a tangent line offset from a flat panel configuration by about 20 degrees, however the curvature or crown of the panels 32 may be varied such that the tangent line would be much steeper or significantly lower, but not coincidental with a flat panel thus the crown on the plenum panel may be shaped between about 5 degrees to about 30 degrees. It should also be noted that although the embodiment described herein utilizes air support on both the supply and return, the return described herein may also be used with a roller supported belt if desired.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

What we claim is:

1. In an air supported conveyor system including an arcuate elongated trough having a series of perforations along the centerline thereof, a driven endless belt positioned within said trough, and a fan system supplying air through said perforations beneath said endless belt to lift said endless belt within said trough, the improvement comprising:
A return support for said endless belt said return including an elongated plenum receiving air from said fan system, said plenum including an upper curved wall extending downwardly from a longitudinal centerline thereof such that said belt is supported along the centerline, said upper curved wall having a series of apertures therethrough beneath said belt such that air from within said plenum flows beneath said belt and outwardly from said centerline.

2. The improvement as defined in claim 1 wherein a tangent from said upper curved wall is between about 5 to 30 degrees.

3. The improvement as defined in claim 1 wherein a tangent from said upper curved wall is between about 15 to about 25 degrees.

4. The improvement as defined in claim 1 wherein a tangent from said upper curved wall is about 20 degrees.

5. The improvement as defined in claim 1 further comprising a housing enclosing said upper curved wall above said belt and extending on either side of said belt to proximal said upper curved wall and displaced from a longitudinal edge of said endless belt.

6. The improvement as defined in claim 1 wherein aid apertures are formed proximal said centerline of said upper curved wall.

7. A return for reducing the buildup of debris beneath a conveyor belt return comprising:
A plenum extending beneath the conveyor and having an upper convex surface supporting said belt in a bowed side to side configuration,
A plurality of apertures formed through said upper convex surface such that air from within said plenum is forced through said apertures beneath said belt such that debris between said belt and said surface is entrained in an airflow towards the edges of said belt.

8. The return as described in claim 7 wherein said upper convex surface is sufficiently arcuate that gravity urges any debris on said surface away from the centerline of said surface toward the edges of said belt.

9. The return as described in claim 7 further comprising a housing over said belt and upper convex surface for containing debris urged from beneath said belt, said housing and said upper convex space defining an edge space there between adjacent said belt wherein debris may accumulate and be urged longitudinally by the edge of said belt moving over said convex surface.

10. A method for removing surface debris from a belt conveyor during the return run of said belt comprising:
Forming said belt into a bowed side to side condition where in the debris laden surface of said belt is concave and facing downwardly,
Supporting said belt in said bowed condition on a concave surface having a plurality of apertures therein;
And directing air through said apertures beneath said belt sufficient to reduce friction between said belt and said concave surface and to urge said debris toward the edge of said belt.
